(19) United States
(12) Patent Application Publication
(10) Pub. No.: US 2019/0001891 A1
(43) Pub. Date: Jan. 3, 2019

(54) VEHICLE ROOF MOUNTED SYSTEM

(71) Applicant: Yazaki Corporation, Tokyo (JP)

(72) Inventors: Masashi SUZUKI, Shizuoka (JP); Jun GOTO, Shizuoka (JP)

(73) Assignee: Yazaki Corporation, Tokyo (JP)

(21) Appl. No.: 15/959,915

(22) Filed: Apr. 23, 2018

(30) Foreign Application Priority Data
Jun. 28, 2017 (JP) 2017-125948

(51) Int. Cl. B60R 1/00; H04N 7/18

(52) U.S. Cl. CPC B60R 1/008; H04N 7/183; B60R 2300/8006; B60R 2300/20; B60R 2300/105

(57) ABSTRACT

A vehicle roof mounted system includes a stereo camera, a display, and a controller. The stereo camera is provided in a vehicle and captures an image including the face of a driver P1 seated in a driver's seat of the vehicle. The display is provided on a roof panel of the vehicle and is located on a front side of the vehicle in a front-rear direction between an auxiliary seat provided on the side of the driver's seat in a vehicle width direction and the driver's seat. Then, the display displays an image captured by the stereo camera such that the image is visually recognizable from a rear seat provided on a rear side of the vehicle in the front-rear direction and the driver's seat. The controller controls the display.

### CROSS-REFERENCE TO RELATED APPLICATION(S)

The present application claims priority to and incorporates by reference the entire contents of Japanese Patent Application No. 2017-125948 filed in Japan on Jun. 28, 2017.

### BACKGROUND OF THE INVENTION

### 1. Field of the Invention

The present invention relates to a vehicle roof mounted system.

### 2. Description of the Related Art

Conventionally, there is a vehicle display system that displays a video capturing the interior of a vehicle on a display of the vehicle. For example, Japanese Patent Application Laid-open No. 2014-223887 discloses a vehicle interior monitoring apparatus including a camera that captures an occupant in a rear seat and a display provided on a dashboard to display an image. This vehicle interior monitoring apparatus displays a video capturing the occupant in the rear seat on the display such that a driver can monitor the occupant in the rear seat.

Meanwhile, the conventional vehicle display system is desired to support communication between occupants (for example, between an occupant on a driver's seat side and an occupant in the rear seat) by displaying an image capturing the occupants on the display.

### SUMMARY OF THE INVENTION

The present invention has been made considering the foregoing and it is therefore an object thereof to provide a vehicle roof mounted system that supports an occupant on a driver's seat side and an occupant in a rear seat to properly communicate with each other.

A vehicle roof mounted system according to one aspect of the present invention includes a first image capturing section provided in a vehicle to capture an image including a face of a driver seated in a driver's seat of the vehicle; an image display section that is provided on a roof panel of the vehicle so as to be located on a front side of the vehicle in a front-rear direction between an auxiliary seat provided on a side of the driver's seat in a vehicle width direction and the driver's seat and displays the image captured by the first image capturing section such that the image is visually recognizable from a rear seat provided on a rear side of the vehicle in the front-rear direction and the driver's seat; and a controller that controls the image display section.

According to another aspect of the present invention, in the vehicle roof mounted system, it is preferable that the vehicle roof mounted system further includes a second image capturing section provided in the vehicle to capture an image including a face of an occupant seated in the rear seat; and a changeover section that changes over an image displayed on the image display section, wherein the controller displays one of the image captured by the first image capturing section and the image captured by the second image capturing section on the image display section in accordance with changeover by the changeover section.

According to still another aspect of the present invention, in the vehicle roof mounted system, it is preferable that the vehicle roof mounted system further includes a housing that accommodates the first image capturing section, the image display section, and the controller.

According to still another aspect of the present invention, in the vehicle roof mounted system, it is preferable that the controller has a monitoring function to monitor a state of the driver on the basis of the image captured by the first image capturing section, and the monitoring function is executed regardless of content displayed on the image display section while the vehicle roof mounted system is in an active state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of a vehicle roof mounted system according to an embodiment;

FIG. 2 is a block diagram illustrating a configuration example of the vehicle roof mounted system according to the embodiment;

FIG. 3 is a perspective view illustrating a configuration example of an overhead module according to the embodiment;

FIG. 4 is a schematic diagram illustrating an action example of the vehicle roof mounted system according to the embodiment;

FIG. 5 is a schematic diagram illustrating an action example of the vehicle roof mounted system according to the embodiment; and

FIG. 6 is a flowchart illustrating an action example of the vehicle roof mounted system according to the embodiment.

### DETAILED DESCRIPTION OF THE PREFERRED EMBODIMENTS

Modes for carrying out the present invention (embodiments) will be described in detail with reference to the drawings. The present invention is not limited by the contents mentioned in the following embodiments. In addition, the constituent elements mentioned below include those which can be easily assumed by persons skilled in the art and practically the same as above. Furthermore, the configurations mentioned below can be appropriately combined. Additionally, a variety of omissions, substitutions, or modifications in the configurations can be made without departing from the gist of the present invention.

### Embodiments

A vehicle roof mounted system 1 according to an embodiment will be described. The vehicle roof mounted system 1 includes a display 15a that is provided on a roof panel 2a of a vehicle 2 so as to be located on a front side of the vehicle 2 in a front-rear direction between a driver's seat 2b and an auxiliary seat 2c and displays an image including a face of a driver P1 captured by a stereo camera 14 such that the image is visually recognizable from a rear seat 2d and the driver's seat 2b. With this configuration, the vehicle roof mounted system 1 can support the driver P1 in the driver's seat 2b and an occupant P3 in the rear seat 2d to properly communicate with each other. Hereinafter, the vehicle roof mounted system 1 will be described in detail.

Note that, in the following description, the front-rear direction is a direction in which the vehicle 2 goes straight and represents a direction equivalent to a total length direction of the vehicle 2. A vehicle width direction is a direction along the width of the vehicle 2. A height direction is a direction along the height of the vehicle 2 and typically represents a vertical direction. The front-rear direction, the vehicle width direction, and the height direction are substantially orthogonal to each other.

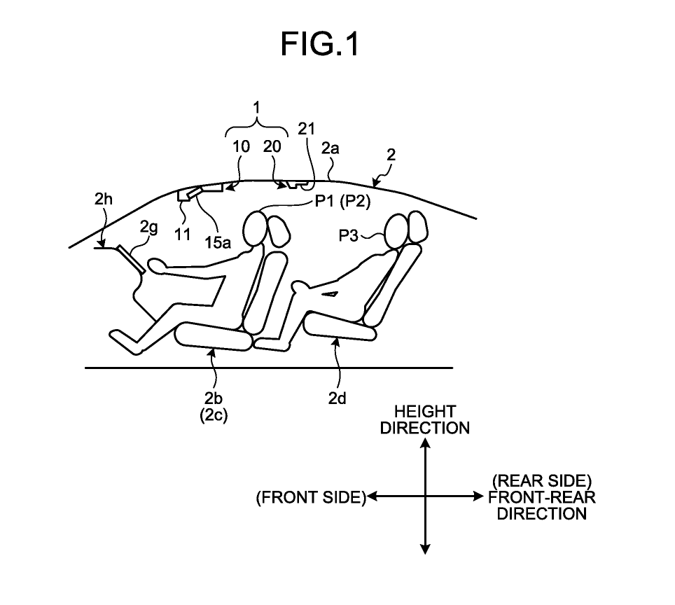

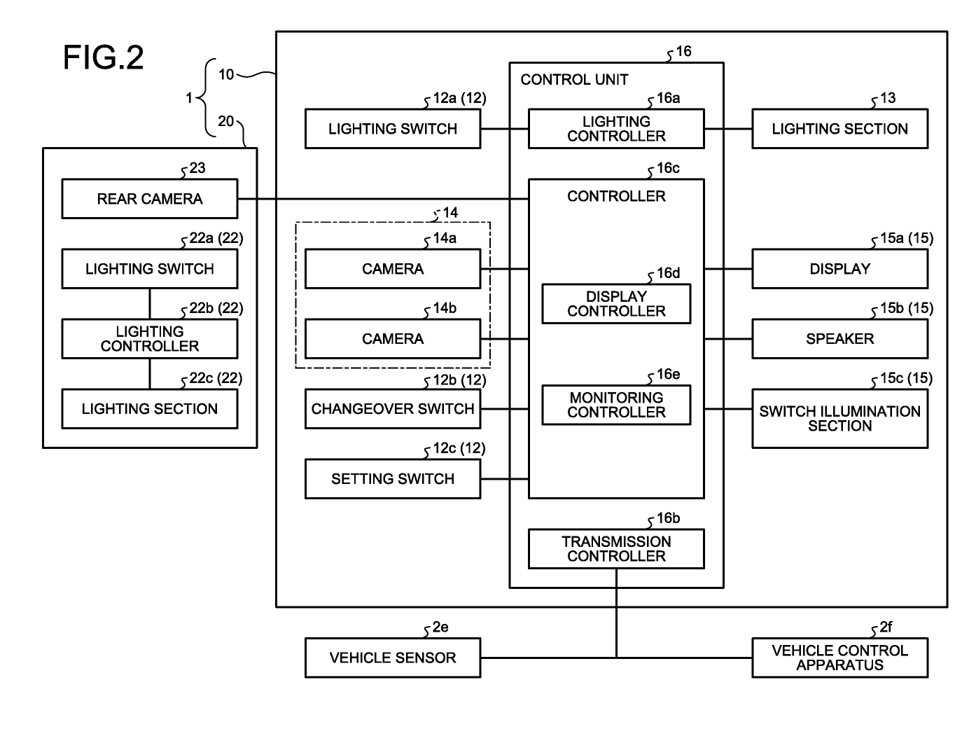

As illustrated in FIG. 1, the vehicle 2 includes the driver's seat 2b on which the driver P1 driving the vehicle 2 is seated, the auxiliary seat 2c provided on a side of the driver's seat 2b in the vehicle width direction, and a plurality of rear seats 2d provided on a rear side of the driver's seat 2b and the auxiliary seat 2c in the front-rear direction of the vehicle 2. The driver's seat 2b is provided on the front side in the front-rear direction at a position opposing a steering wheel of the vehicle 2. The auxiliary seat 2c is a so-called passenger seat and is provided next to the driver's seat 2b in the vehicle width direction. In the example here, the respective rear seats 2d are provided in a row along the vehicle width direction but are not limited to this arrangement. The rear seats 2d may be provided in a plurality of rows along the vehicle width direction. As illustrated in FIG. 2, the vehicle 2 further includes a vehicle sensor 2e, a vehicle control apparatus 2f, and a center display 2g (refer to FIG. 1). The vehicle sensor 2e is, for example, a sensor that detects the vehicle speed and the like of the vehicle 2. The vehicle sensor 2e is connected to a transmission controller 16b to be described later and outputs the result of the detection to the transmission controller 16b. The vehicle control apparatus 2f is an apparatus that controls the entire vehicle 2 and includes an electronic control unit (ECU) in the configuration. The vehicle control apparatus 2f is connected to the transmission controller 16b and controls the vehicle 2 on the basis of a warning signal output from the transmission controller 16b. For example, when the warning signal indicates that the vehicle 2 is to be stopped, the vehicle control apparatus 2f makes a judgment including other information and controls to safely stop the vehicle 2. The center display 2g is, for example, a display apparatus that displays navigation information for guiding a route of driving, and the like and is provided on an instrument panel 2h of the vehicle 2.

The vehicle roof mounted system 1 includes an overhead module 10 and a rear module 20. The overhead module 10 is an apparatus that outputs a video capturing the interior of the vehicle 2, and the like. In addition, the overhead module 10 is an apparatus that monitors the state of the driver P1, such as dozing, on the basis of the captured video to give a warning. Since the overhead module 10 also includes a monitoring function, it is possible to reduce the number of components as compared with a conventional case where an apparatus having a monitoring function is installed separately. Furthermore, since the overhead module 10 can separate this monitoring function from a conventional input/output apparatus (not illustrated) related to driving, it is possible to allow a margin in the layout of the instrument panel 2h provided with this input/output apparatus. The overhead module 10 is provided on an interior side of the roof panel 2a of the vehicle 2. The overhead module 10 is located on the roof panel 2a on the front side in the front-rear direction between the driver's seat 2b and the auxiliary seat 2c. That is, the overhead module 10 is located on the roof panel 2a at a center portion in the vehicle width direction of the vehicle 2 on a windshield side. The overhead module 10 includes a housing 11, a switch section 12, a lighting section 13, the stereo camera 14 as a first image capturing section, an output section 15, and a control unit 16.

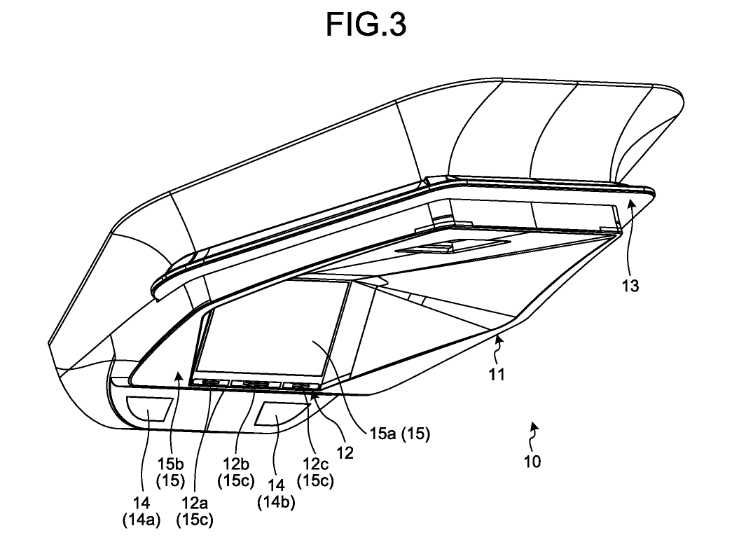

The housing 11 is formed of synthetic resin or the like and has an internal space portion. As illustrated in FIG. 3, the switch section 12, the lighting section 13, the stereo camera 14, the output section 15, and the control unit 16 are accommodated in this internal space portion. The housing 11 accommodates the switch section 12 such that the switch section 12 is operable from an outer side of the housing 11 and accommodates the lighting section 13 capable of irradiating the outer side of the housing 11 with light. The housing 11 also accommodates the stereo camera 14 capable of capturing the interior of the vehicle 2, and the like and accommodates the output section 15 capable of outputting an image, audio, and the like to the interior of the vehicle 2. In addition, the housing 11 accommodates the control unit 16 in a protected state from the outside.

The switch section 12 includes a plurality of switches operated by the driver P1 and an occupant P2 in the auxiliary seat 2c. The switch section 12 has, for example, a lighting switch 12a, a changeover switch 12b as a changeover section, and a setting switch 12c. The lighting switch 12a is a switch that turns on and off the lighting section 13 and is operated by the driver P1 or the occupant P2 in the auxiliary seat 2c. The lighting switch 12a is connected to a lighting controller 16a to be described later and outputs a light-on signal or a light-off signal to the lighting controller 16a. The changeover switch 12b is a switch that changes over an image displayed on the display 15a to be described later and is operated by the driver P1 or the occupant P2 in the auxiliary seat 2c. The changeover switch 12b is connected to a display controller 16d to be described later and outputs a changeover signal to the display controller 16d. The setting switch 12c is a switch that turns on and off the monitoring function to monitor the state of the driver P1, such as dozing, and is operated by the driver P1 or the occupant P2 in the auxiliary seat 2c. The setting switch 12c is connected to a monitoring controller 16e and outputs a setting signal to the monitoring controller 16e.

The lighting section 13 is a device that illuminates the driver's seat 2b and the auxiliary seat 2c of the vehicle 2 with light. For example, the lighting section 13 is embedded with a light emitting diode (LED) and is connected to the lighting controller 16a. The lighting section 13 turns on light under the control of the lighting controller 16a.

The stereo camera 14 is an image capturing apparatus having a pair of cameras 14a and 14b. In the stereo camera 14, the respective cameras 14a and 14b are arranged along the vehicle width direction and lenses of the cameras 14a and 14b are both arranged in orientations in which the driver's seat 2b and the auxiliary seat 2c are shot. For example, the stereo camera 14 is set to an angle at which the angle of view includes the face of the driver P1 seated in the driver's seat 2b and the face of the occupant P2 seated in the auxiliary seat 2c in an image. The stereo camera 14 captures an image including three-dimensional information (hereinafter also referred to as a three-dimensional image). The stereo camera 14 makes it possible to recognize a capturing target in three dimensions from a difference (parallax) in positions of the capturing target appearing in images captured by the respective cameras 14a and 14b. The stereo camera 14 captures an image including the face of the driver P1 seated in the driver's seat 2b and the face of the occupant P2 seated in the auxiliary seat 2c. Note that, in the stereo camera 14, the figure of the occupant P3 in the rear seat 2d may be included in the image in addition to the face of the driver P1 and the face of the occupant P2 in the auxiliary seat 2c. The stereo camera 14 outputs the image captured by the cameras 14a and 14b to a controller 16c.

The output section 15 is a device that outputs information. The output section 15 is connected to the controller 16c and outputs various items of information under the control of the controller 16c. The output section 15 includes the display 15a as an image display section, a speaker 15b, and a switch illumination section 15c. The display 15a is a device that displays image information. For example, a liquid crystal display (LCD), an organic electro-luminescence (EL), or the like is used as the display 15a. The display 15a is assembled to the overhead module 10 such that the image can be visually recognized from the driver's seat 2b, the auxiliary seat 2c, and the rear seat 2d. In the display 15a, a display screen of the display 15a is arranged to face sides of the driver's seat 2b, the auxiliary seat 2c, and the rear seat 2d. Since the display 15a is provided on the roof panel 2a, the display 15a is unlikely to be included in the line of sight (field of view) of the driver P1 pointed ahead of the vehicle 2 during traveling of the vehicle 2. The display 15a is included in the field of view of the driver P1 when the driver P1 points the line of sight to an upper side in the height direction. Similarly, the display 15a is included in the field of view of the occupant P2 in the auxiliary seat 2c when the occupant P2 in the auxiliary seat 2c points the line of sight to the upper side in the height direction. Similarly, the display 15a is included in the field of view of the occupant P3 in the rear seat 2d when the occupant P3 in the rear seat 2d points the line of sight to the upper side in the height direction. The display 15a is connected to the display controller 16d and displays an image captured by the stereo camera 14, an image captured by a rear camera 23 of the rear module 20 to be described later, or an image of another function under the control of the display controller 16d.

The speaker 15b is a device that outputs audio information. The speaker 15b is assembled to the overhead module 10 such that audio can be listened to from the driver's seat 2b, the auxiliary seat 2c, and the rear seat 2d. The speaker 15b is connected to the monitoring controller 16e and outputs audio under the control of the monitoring controller 16e.

The switch illumination section 15c is a device provided in the switch section 12 to emit light. The switch illumination section 15c includes, for example, an LED or the like in the configuration. The switch illumination section 15c is connected to the monitoring controller 16e and lights or blinks under the control of the monitoring controller 16e.

The control unit 16 controls each device of the overhead module 10. The control unit 16 includes, in the configuration, an electronic circuit mainly made up of a well-known microcomputer including a central processing unit (CPU), and a read only memory (ROM), a random access memory (RAM), and an interface constituting a storage section. The control unit 16 includes the lighting controller 16a, the transmission controller 16b, and the controller 16c.

The lighting controller 16a is a circuit that controls the lighting section 13. The lighting controller 16a is connected to the lighting switch 12a and the lighting section 13 and controls to turn on or off light of the lighting section 13 on the basis of the light-on signal or the light-off signal output from the lighting switch 12a.

The transmission controller 16b is a circuit that establishes transmission with the vehicle sensor 2e and the vehicle control apparatus 2f. The transmission controller 16b is connected to the vehicle sensor 2e and a detection result for the vehicle 2, such as the vehicle speed, is output from the vehicle sensor 2e. In addition, when it is determined by the controller 16c to be described later that the driver P1 is in an inappropriate situation for driving including dozing, the transmission controller 16b outputs a warning signal indicating that the situation is inappropriate for driving to the vehicle control apparatus 2f.

The controller 16c is a circuit that controls the output section 15. The controller 16c is connected to the stereo camera 14, the changeover switch 12b, the setting switch 12c, and the output section 15 and controls the output section 15 on the basis of various types of signals output from the stereo camera 14, the changeover switch 12b, and the setting switch 12c. The controller 16c includes the display controller 16d and the monitoring controller 16e. For example, the display controller 16d outputs, to the display 15a, a two-dimensional image output from the stereo camera 14, which has been acquired to generate the three-dimensional image. For example, the display controller 16d acquires an image captured by one of the cameras 14a and 14b of the stereo camera 14 and outputs the acquired image to the display 15a as the two-dimensional image. The display controller 16d works independently from the monitoring controller 16e and displays an image on the display 15a regardless of the setting of the monitoring controller 16e.

The monitoring controller 16e recognizes the capturing target in three dimensions on the basis of the image output from the stereo camera 14 and determines, for example, a situation of the driver P1 inappropriate for driving including the dozing. Here, the three-dimensional image is an image based on images captured by both of the cameras 14a and 14b of the stereo camera 14. The monitoring controller 16e determines the dozing of the driver P1 on the basis of, for example, the position of the head of the driver P1 seated in the driver's seat 2b and the expression of the face of the driver P1 (opening and closing of the eyes). For example, the monitoring controller 16e determines that the driver P1 is dozing in a case where the position of the head of the driver P1 is located on the front side of a predetermined reference position in the front-rear direction for a fixed time or a case where the eyes of the driver P1 are closed for a fixed time while the vehicle speed output from the vehicle sensor 2e is equal to or higher than a predetermined reference vehicle speed. The monitoring controller 16e controls the speaker 15b and the switch illumination section 15c on the basis of this determination result. For example, when it is determined that the driver P1 is dozing, the monitoring controller 16e outputs audio indicating a warning from the speaker 15b and also gives a warning by lighting or blinking the switch illumination section 15c. In a case where it is determined that the driver P1 is not dozing, the monitoring controller 16e does not give a warning from the speaker 15b and the switch illumination section 15c. The monitoring controller 16e works independently from the display controller 16d. In a case where an ignition (IGN) power supply is turned on and the vehicle roof mounted system 1 is in an active state, the monitoring controller 16e executes monitoring processing regardless of the content displayed on the display 15a by the display controller 16d.

The monitoring controller 16e turns on and off the above monitoring function on the basis of the setting signal output from the setting switch 12c. The monitoring controller 16e turns on the monitoring function in a case where the setting signal indicates the turning on of the monitoring function and turns off the monitoring function in a case where the setting signal indicates the turning off of the monitoring function. The display controller 16d changes over the image displayed on the display 15a on the basis of the changeover signal output from the changeover switch 12b. For example, on the basis of the changeover signal, the display controller 16d displays, on the display 15a, an image captured by the stereo camera 14, an image captured by the rear camera 23 of the rear module 20, or an image of another function (for example, the image of a clock or the like), which is an image other than the image captured by the stereo camera 14 and the image captured by the rear camera 23. In a case where the changeover signal indicates the display of an image from the stereo camera 14, the display controller 16d displays the image captured by the stereo camera 14 on the display 15a. Meanwhile, in a case where the changeover signal indicates the display of an image from the rear camera 23 of the rear module 20, the display controller 16d displays the image captured by the rear camera 23 of the rear module 20 on the display 15a. In addition, in a case where the changeover signal indicates the display of an image of another function, the display controller 16d displays an image of another function on the display 15a.

The rear module 20 is an apparatus that captures an image including the face of the occupant P3 seated in the rear seat 2d. The rear module 20 is provided on the interior side of the roof panel 2a of the vehicle 2. For example, the rear module 20 is located at the center portion in the vehicle width direction closer to the rear side of the vehicle 2 than the overhead module 10 in the front-rear direction. The rear module 20 includes a housing 21, a lighting apparatus 22, and the rear camera 23 as a second image capturing section. The housing 21 is formed of synthetic resin or the like and has an internal space portion. The lighting apparatus 22 and the rear camera 23 are accommodated in this internal space portion. The lighting apparatus 22 is an apparatus that illuminates the rear seat 2d with light and has a lighting switch 22a, a lighting controller 22b, and a lighting section 22c. The lighting switch 22a is a switch that turns on and off the lighting section 22c and is operated, for example, by the occupant P3 in the rear seat 2d. The lighting switch 22a is connected to the lighting controller 22b and outputs the light-on signal or the light-off signal to the lighting controller 22b. The lighting controller 22b is a circuit that controls the lighting section 22c. The lighting controller 22b is connected to the lighting switch 22a and the lighting section 22c and controls to turn on or off light of the lighting section 22c on the basis of the light-on signal or the light-off signal output from the lighting switch 22a. The lighting section 22c is a device that illuminates the rear seat 2d of the vehicle 2 with light and is, for example, an LED. The lighting section 22c is connected to the lighting controller 22b and turns on light under the control of the lighting controller 22b. The rear camera 23 is, for example, a monocular camera and a lens of the rear camera 23 is arranged to face a side of the rear seat 2d. For example, the rear camera 23 is set to an angle at which the angle of view includes the face of the occupant P3 seated in the rear seat 2d in an image. The rear camera 23 captures an image including the face of the occupant P3 seated in the rear seat 2d. The rear camera 23 outputs the captured image to the display controller 16d.

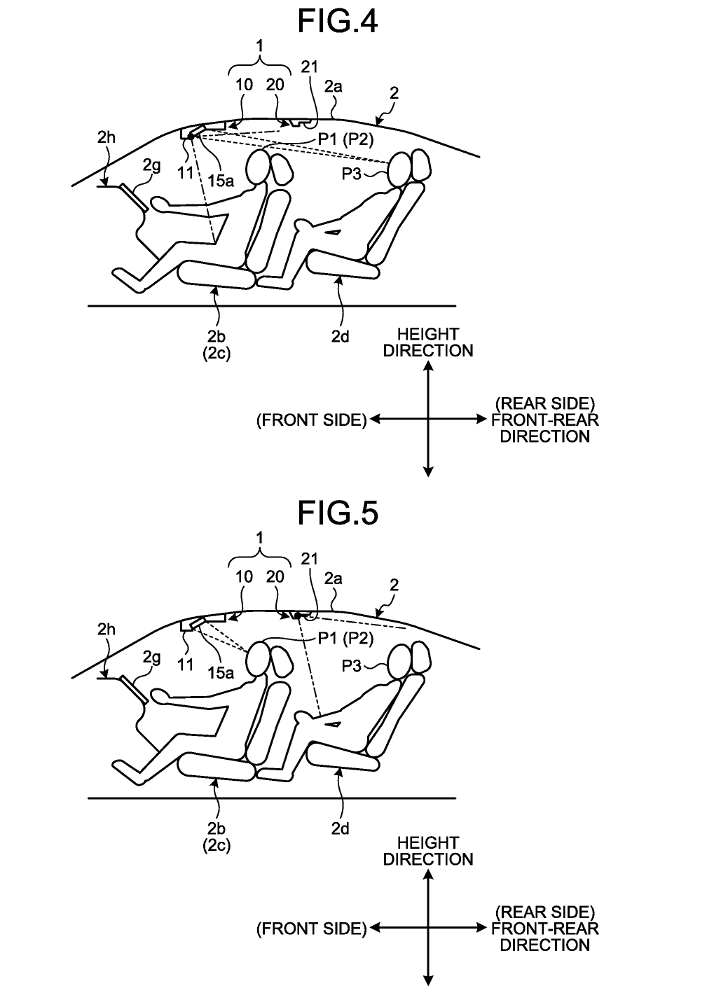

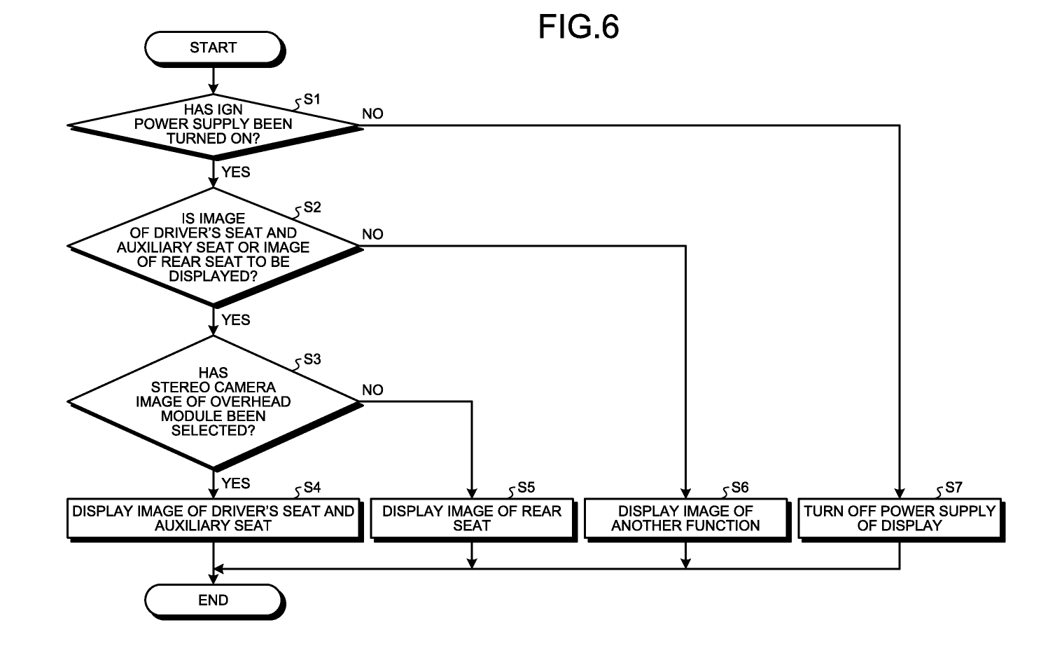

Next, action examples of the vehicle roof mounted system 1 will be described with reference to FIGS. 4, 5, and 6. The vehicle roof mounted system 1 determines whether the IGN power supply has been turned on (step S1). In a case where the IGN power supply is turned on and the active state is initiated (step S1; Yes), the vehicle roof mounted system 1 determines whether the image of the driver's seat and the auxiliary seat or the image of the rear seat is to be displayed, or alternatively, an image of another function is to be displayed as the display content of the display 15a (step S2). For example, the display controller 16d determines whether the changeover signal output from the changeover switch 12b is a signal indicating the display of an image from the stereo camera 14 or the display of an image from the rear camera 23 of the rear module 20, or alternatively, a signal indicating the display of an image other than that of the stereo camera 14 or the rear camera 23. In a case where the image of the driver's seat and the auxiliary seat or the image of the rear seat is to be displayed (step S2; Yes), the vehicle roof mounted system 1 determines whether a stereo camera image of the overhead module 10 has been selected (step S3). For example, the display controller 16d determines whether the changeover signal output from the changeover switch 12b is a signal indicating the display of an image from the stereo camera 14 or a signal indicating the display of an image from the rear camera 23 of the rear module 20. In a case where the stereo camera image of the overhead module 10 has been selected (step S3; Yes), the vehicle roof mounted system 1 displays the image of the driver's seat 2b and the auxiliary seat 2c captured by the stereo camera 14 on the display 15a as illustrated in FIG. 4 (step S4). For example, the display controller 16d displays, on the display 15a, an image including the face of the driver P1 seated in the driver's seat 2b and the face of the occupant P2 seated in the auxiliary seat 2c. At this time, the occupant P3 in the rear seat 2d can communicate with the driver P1 and the occupant P2 in the auxiliary seat 2c while visually recognizing the image including the face of the driver P1 and the face of the occupant P2 in the auxiliary seat 2c displayed on the display 15a. On the other hand, in a case where the stereo camera image of the overhead module 10 has not been selected, that is, a case where the rear camera 23 of the rear module 20 has been selected (step S3; No), the vehicle roof mounted system 1 displays the image of the rear seat 2d captured by the rear camera 23 of the rear module 20 on the display 15a as illustrated in FIG. 5 (step S5). For example, the display controller 16d displays an image including the face of the occupant P3 seated in the rear seat 2d on the display 15a. At this time, the driver P1 can communicate with the occupant P3 in the rear seat 2d while visually recognizing the image including the face of the occupant P3 in the rear seat 2d displayed on the display 15a. In addition, the vehicle roof mounted system 1 displays an image of another function (step S6) in a case where, in above step S2, the image of the driver's seat and the auxiliary seat or the image of the rear seat is not to be displayed (step S2; No). In above step S1, in a case where the IGN power supply is turned off (step S1; No), the vehicle roof mounted system 1 turns off the power supply of the display 15a (step S7).

As described above, the vehicle roof mounted system 1 according to the embodiment includes the stereo camera 14, the display 15a, and the display controller 16d. The stereo camera 14 is provided in the vehicle 2 and captures an image including the face of the driver P1 seated in the driver's seat 2b of the vehicle 2. The display 15a is provided on the roof panel 2a of the vehicle 2 and is located on the front side of the vehicle 2 in the front-rear direction between the auxiliary seat 2c provided on the side of the driver's seat 2b in the vehicle width direction and the driver's seat 2b. Then, the display 15a displays the image captured by the stereo camera 14 such that the image is visually recognizable from the rear seat 2d provided on the rear side of the vehicle 2 in the front-rear direction and the driver's seat 2b. The display controller 16d controls the display 15a.

With this configuration, in the vehicle roof mounted system 1, the occupant P3 seated in the rear seat 2d can visually recognize the image including the face of the driver P1 displayed on the display 15a. With this configuration, the vehicle roof mounted system 1 can support the occupant P3 seated in the rear seat 2d and the driver P1 to smoothly communicate with each other. That is, the vehicle roof mounted system 1 can support the occupant P3 seated in the rear seat 2d to communicate with the driver P1 while preventing the occupant P3 from taking a posture of bending forward to look into the side of the driver's seat 2b. As a result, the vehicle roof mounted system 1 can support the driver P1 and the occupant P3 in the rear seat 2d to properly communicate with each other. In addition, the vehicle roof mounted system 1 displays the image of the driver P1, the occupant P3, or the like on the display 15a different from the center display 2g that displays the navigation information and the like. With this display, the vehicle roof mounted system 1 can continuously display the image of the driver P1, the occupant P3, or the like on the display 15a without being disturbed by the navigation information or the like. Furthermore, the occupant P3 in the rear seat 2d can see that the driver P1 is drowsy by visually recognizing a face image of the driver P1, whereby the vehicle roof mounted system 1 can support the suppression of dozing while driving.

The vehicle roof mounted system 1 described above includes the rear camera 23 and the changeover switch 12b. The rear camera 23 is provided in the vehicle 2 and captures an image including the face of the occupant P3 seated in the rear seat 2d. The changeover switch 12b changes over the image displayed on the display 15a. The display controller 16d displays one of the image captured by the stereo camera 14 and the image captured by the rear camera 23 on the display 15a in accordance with the changeover by the changeover switch 12b. Furthermore, the display controller 16d displays an image of another function (for example, the image of a clock or the like), which is an image other than the image captured by the stereo camera 14 and the image captured by the rear camera 23, on the display 15a in accordance with the changeover by the changeover switch 12b.

With this configuration, in the vehicle roof mounted system 1, the driver P1 can visually recognize the image including the face of the occupant P3 in the rear seat 2d displayed on the display 15a. With this configuration, the vehicle roof mounted system 1 can support the driver P1 and the occupant P3 in the rear seat 2d to smoothly communicate with each other. That is, the vehicle roof mounted system 1 can support the driver P1 to communicate with the occupant P3 in the rear seat 2d without turning back toward the side of the rear seat 2d. In addition, the vehicle roof mounted system 1 can support the driver P1 to monitor the state of the occupant P3 in the rear seat 2d by visually recognizing the image including the face of the occupant P3 in the rear seat 2d.

The vehicle roof mounted system 1 described above includes the housing 11 that accommodates the stereo camera 14, the display 15a, and the controller 16c. With this configuration, the vehicle roof mounted system 1 can provide the overhead module 10 in which electronic components including the stereo camera 14, the display 15a, and the controller 16c are integrated to be modularized. With this configuration, in the vehicle roof mounted system 1, since the respective electronic components can be assembled to the vehicle 2 at the same time when the overhead module 10 is assembled to the vehicle 2, the number of assembling procedures can be reduced. The vehicle roof mounted system 1 also can reduce wiring harnesses and connecting members for connecting each electronic component.

In the vehicle roof mounted system 1 described above, the controller 16c has the monitoring function to monitor the state of the driver P1 on the basis of the image captured by the stereo camera 14. The monitoring function is executed regardless of the content displayed on the display 15a while the vehicle roof mounted system 1 is in the active state. With this configuration, the vehicle roof mounted system 1 can continuously monitor the state of the driver P1 while being in the active state.

Modifications

Next, modifications of the embodiment will be described. The stereo camera 14 may be a time-of-flight (TOF) camera having a function of capturing a three-dimensional image.

In addition, the monitoring function of the vehicle roof mounted system 1 may be implemented by a different device. Meanwhile, the vehicle roof mounted system 1 may not have the monitoring function. In this case, the stereo camera 14 of the vehicle roof mounted system 1 may be replaced with a monocular camera which does not have the function of capturing the three-dimensional image.

Furthermore, although an example of the stereo camera 14 configured to capture the face of the driver P1 and the face of the occupant P2 in the auxiliary seat 2c has been described, the face of the occupant P2 in the auxiliary seat 2c may not be captured.

The vehicle roof mounted system according to the present embodiments includes the image display section that is provided on the roof panel of the vehicle so as to be located on the front side of the vehicle in the front-rear direction between the auxiliary seat and the driver's seat and displays an image including the face of the driver captured by the first image capturing section such that the images is visually recognizable from the rear seat and the driver's seat, thereby being able to support an occupant on a driver's seat side and an occupant in the rear seat to properly communicate with each other.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle roof mounted system comprising:
a first image capturing section provided in a vehicle to capture an image including a face of a driver seated in a driver's seat of the vehicle;
an image display section that is provided on a roof panel of the vehicle so as to be located on a front side of the vehicle in a front-rear direction between an auxiliary seat provided on a side of the driver's seat in a vehicle width direction and the driver's seat and displays the image captured by the first image capturing section such that the image is visually recognizable from a rear seat provided on a rear side of the vehicle in the front-rear direction and the driver's seat; and
a controller that controls the image display section.

2. The vehicle roof mounted system according to claim 1, further comprising:
a second image capturing section provided in the vehicle to capture an image including a face of an occupant seated in the rear seat; and
a changeover section that changes over an image displayed on the image display section, wherein
the controller displays one of the image captured by the first image capturing section and the image captured by the second image capturing section on the image display section in accordance with changeover by the changeover section.

3. The vehicle roof mounted system according to claim 1, further comprising:
a housing that accommodates the first image capturing section, the image display section, and the controller.

4. The vehicle roof mounted system according to claim 2, further comprising:
a housing that accommodates the first image capturing section, the image display section, and the controller.

5. The vehicle roof mounted system according to claim 1, wherein
the controller has a monitoring function to monitor a state of the driver on the basis of the image captured by the first image capturing section, and
the monitoring function is executed regardless of content displayed on the image display section while the vehicle roof mounted system is in an active state.

6. The vehicle roof mounted system according to claim 2, wherein
the controller has a monitoring function to monitor a state of the driver on the basis of the image captured by the first image capturing section, and
the monitoring function is executed regardless of content displayed on the image display section while the vehicle roof mounted system is in an active state.

7. The vehicle roof mounted system according to claim 3, wherein
the controller has a monitoring function to monitor a state of the driver on the basis of the image captured by the first image capturing section, and
the monitoring function is executed regardless of content displayed on the image display section while the vehicle roof mounted system is in an active state.
